(19) United States
(12) Patent Application Publication
(10) Pub. No.: US 2007/0004871 A1
(43) Pub. Date: Jan. 4, 2007

(54) Curable composition and method

(76) Inventors: Qiwei Lu, Schenectady, NY (US); Michael O'Brien, Clifton Park, NY (US); Prameela Susarla, Clifton Park, NY (US); Michael Vallance, Loudonville, NY (US)

Correspondence Address: CANTOR COLBURN, LLP, 55 GRIFFIN ROAD SOUTH, BLOOMFIELD, CT, 06002, US

(21) Appl. No.: 11/171,092

(22) Filed: Jun. 30, 2005

(51) Int. Cl. C08L 63/00; C08L 71/02

(52) U.S. Cl. 525/396

(57) ABSTRACT

A curable resin composition useful for encapsulating solid state devices is described. The composition includes an epoxy resin, a poly(arylene ether) resin, a latent cationic cure catalyst effective to cure the epoxy resin, and about 70 to about 95 weight percent of an inorganic filler, based on the total weight of the curable composition. A method of encapsulating a solid state device with the composition and encapsulated devices prepared with the composition are also described.

### BACKGROUND OF THE INVENTION

Solid state electronic devices are typically encapsulated in plastic via transfer molding. Encapsulation protects the device from environmental and mechanical damage and electrically isolates the device. There are many desired technical features of encapsulant compositions. Encapsulation of wire-bonded devices requires low viscosity encapsulant injection, followed by rapid cure and hot ejection. The encapsulated device must subsequently withstand the rigor of solder assembly onto a circuit card. The encapsulant must be self-extinguishing in the event of a heat-producing malfunction of the circuit. And the encapsulant should preferably be environmentally friendly—flame retardants such as aromatic halides and antimony oxide should be avoided.

The encapsulation compositions that are currently commercially favored comprise an epoxy resin, a phenolic hardener, a nucleophilic accelerator to promote stepwise polymerization, and a mineral filler. These compositions must be refrigerated before use, leading to increased costs associated with transportation, storage, and waste. The compositions also suffer from water absorption in the cured state that detracts from desired physical properties. Furthermore, the compositions often exhibit significant shrinkage during curing, which creates stresses that decrease the durability of the cured encapsulation material and can adversely affect the reliability of the encapsulated electronic device. There is therefore a need for encapsulation compositions that exhibit improved storage properties, reduced water absorption, and reduced shrinkage on curing.

### BRIEF DESCRIPTION OF THE INVENTION

The above-described and other drawbacks are alleviated by a curable composition comprising an epoxy resin, a poly(arylene ether) resin, an amount of a latent cationic cure catalyst effective to cure the epoxy resin; and about 70 to about 95 weight percent of an inorganic filler, based on the total weight of the curable composition.

Other embodiments include a method of preparing the curable composition, a method of encapsulating a solid state device, and a solid state device encapsulated by the curable composition, as well as its partially cured and fully cured counterparts.

These and other embodiments are described in detail below.

### BRIEF DESCRIPTION OF THE DRAWING

FIG. 1 is a side cross-sectional view of an encapsulated solid state device.

### DETAILED DESCRIPTION OF THE INVENTION

One embodiment is a curable composition comprising an epoxy resin, a poly(arylene ether) resin, an amount of a latent cationic cure catalyst effective to cure the epoxy resin; and about 70 to about 95 weight percent of an inorganic filler, based on the total weight of the curable composition. In the course of extensive research, the present inventors have discovered that these curable compositions, when compared to current epoxy-based encapsulation compositions, exhibit improved storage properties, reduced shrinkage during curing, and reduced water absorption in the cured state. In one embodiment, the curable compositions incorporate a flame retardant that provides excellent flame retardance while avoiding the environmental disadvantages of halogenated aromatic compounds and antimony oxide and not interfering with the curing reaction.

While not wishing to be bound by any particular theory of operation, the present inventors believe that the present compositions cure by cationic, ring-opening, chain-reaction polymerization. The latent cationic cure catalyst decomposes on heating during the curing step to produce a strong Bronsted acid, which initiates ring-opening polymerization. The curing reaction thus forms ether linkages, rather than beta-hydroxy ether linkages, resulting in reduced hydrophilicity (and therefore reduced water absorption) in the cured state.

The curable composition comprises an epoxy resin. Suitable classes of epoxy resins include, for example, aliphatic epoxy resins, cycloaliphatic epoxy resins, bisphenol-A epoxy resins, bisphenol-F epoxy resins, phenol novolac epoxy resins, cresol-novolac epoxy resins, biphenyl epoxy resins, polyfunctional epoxy resins (i.e., epoxy resins comprising at least three epoxy groups), naphthalene epoxy resins (e.g., EPICLON® EXA-4700 from Dainippon Ink and Chemicals), divinylbenzene dioxide, 2-glycidylphenylglycidyl ether, dicyclopentadiene-type (DCPD-type) epoxy resins (e.g., EPICLON® HP-7200 from Dainippon Ink and Chemicals), multi aromatic resin type (MAR-type) epoxy resins, and the like, and combinations thereof. All of these classes of epoxy resins are known in the art and are both widely commercially available and preparable by known methods. Specific suitable epoxy resins are described, for example, in U.S. Pat. No. 4,882,201 to Crivello et al., U.S. Pat. No. 4,920,164 to Sasaki et al., U.S. Pat. No. 5,015,675 to Walles et al., U.S. Pat. No. 5,290,883 to Hosokawa et al., U.S. Pat. No. 6,333,064 to Gan, U.S. Pat. No. 6,518,362 to Clough et al, U.S. Pat. No. 6,632,892 to Rubinsztajn et al., U.S. Pat. No. 6,800,373 to Gorczyca, U.S. Pat. No. 6,878,632 to Yeager et al.; U.S. Patent Application Publication No. 2004/0166241 to Gallo et al., and WO 03/072628 A1 to Ikezawa et al. In one embodiment, the epoxy resin has a softening point of about 25° C. to about 150° C. Within this range, the melting point may be at least about 30° C. or at least about 35° C. Also within this range, the melting point may be up to about 100° C. or up to about 50° C. Softening points may be determined according to ASTM E28-99 (2004). While it is possible to use epoxy resins with softening points below 25° C., the amounts of such resins should be low enough so as not to interfere with the desired friability of the curable composition as a whole.

In one embodiment, the epoxy resin comprises a monomeric epoxy resin (e.g., 3,3′,5,5′-tetramethyl-4,4′-diglycidyloxybiphenyl, available as RSS1407LC from Yuka Shell), and an oligomeric epoxy resin (e.g., an epoxidized cresol novolac resin, or a multi aromatic resin such as Nippon Kayaku's NC3000). Monomeric epoxy resins are typically crystalline solids, whereas oligomeric epoxy resins are typically glasses.

The curable composition may comprise the epoxy resin in an amount of about 70 to about 98 parts by weight per 100 parts by weight total of the epoxy resin and the poly(arylene ether) resin. Within this range, the epoxy resin amount may be at least about 80 parts by weight, or at least about 85 parts by weight. Also within this range, the epoxy resin amount may be up to about 95 parts by weight, or up to about 90 parts by weight.

The curable composition comprises a poly(arylene ether) resin. In one embodiment, the poly(arylene ether) resin comprises a plurality of repeating units having the structure 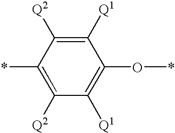
wherein each occurrence of Q² is independently hydrogen, halogen, primary or secondary C₁-C₁₂ alkyl, C₂-C₁₂ alkenyl, C₃-C₁₂ alkenylalkyl, C₂-C₁₂ alkynyl, C₃-C₁₂ alkynylalkyl, C₁-C₁₂ hydroxyalkyl, phenyl, C₁-C₁₂ haloalkyl, C₁-C₁₂ hydrocarbyloxy, C₂-C₁₂ halohydrocarbyloxy wherein at least two carbon atoms separate the halogen and oxygen atoms, or the like; and wherein each occurrence of Q¹ is independently halogen, primary or secondary C₁-C₁₂ alkyl, C₂-C₁₂ alkenyl, C₃-C₁₂ alkenylalkyl, C₂-C₁₂ alkynyl, C₃-C₁₂ alkynylalkyl, C₁-C₁₂ hydroxyalkyl, phenyl, C₁-C₁₂ haloalkyl, C₁-C₁₂ hydrocarbyloxy, or C₂-C₁₂ halohydrocarbyloxy wherein at least two carbon atoms separate the halogen and oxygen atoms, or the like.

In one embodiment, the poly(arylene ether) resin may have an intrinsic viscosity of about 0.03 to 1 deciliters per gram measured at 25° C. in chloroform. Within this range, the intrinsic viscosity may be at least about 0.1 deciliters per gram, of at least about 0.2 deciliters per gram. Also within this range, the intrinsic viscosity may be up to about 0.6 deciliters per gram, or up to about 0.4 deciliters per gram. Methods of preparing poly(arylene ether) resins are known in the art and include, for example, U.S. Pat. Nos. 3,306,874 and 3,306,875 to Hay.

In another embodiment, the poly(arylene ether) resin may have an intrinsic viscosity of about 0.03 to 0.15 deciliters per gram measured at 25° C. in chloroform. Within this range, the intrinsic viscosity may be at least about 0.05 deciliters per gram, or at least about 0.07 deciliters per gram. Also within this range, the intrinsic viscosity may be up to about 0.12 deciliters per gram, or up to about 0.10 deciliters per gram. Methods of preparing low intrinsic viscosity poly(arylene ether) resins include, for example, those described in U.S. Pat. No. 6,307,010 B1 to Braat et al., and U.S. Patent Application Publication No. 2005/0070685 A1 to Mitsui et al.

In one embodiment, the poly(arylene ether) resin has the structure 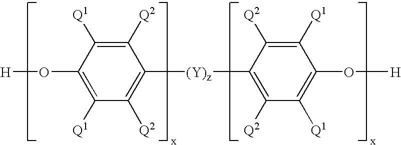
wherein each occurrence of Q² is independently hydrogen, halogen, primary or secondary C₁-C₁₂ alkyl, C₂-C₁₂ alkenyl, C₃-C₁₂ alkenylalkyl, C₂-C₁₂ alkynyl, C₃-C₁₂ alkynylalkyl, C₁-C₁₂ hydroxyalkyl, phenyl, C₁-C₁₂ haloalkyl, C₁-C₁₂ hydrocarbyloxy, C₂-C₁₂ halohydrocarbyloxy wherein at least two carbon atoms separate the halogen and oxygen atoms, or the like; and wherein each occurrence of Q¹ is independently hydrogen, halogen, primary or secondary C₁-C₁₂ alkyl, C₂-C₁₂ alkenyl, C3-C₁₂ alkenylalkyl, C₂-C₁₂ alkynyl, C₃-C₁₂ alkynylalkyl, C₁-C₁₂ hydroxyalkyl, phenyl, C₁-C₁₂ haloalkyl, C₁-C₁₂ hydrocarbyloxy, C₂-C₁₂ halohydrocarbyloxy wherein at least two carbon atoms separate the halogen and oxygen atoms, or the like; each occurrence of x is independently 1 to about 100; z is 0 or 1; and Y has a structure selected from 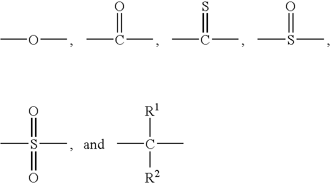
wherein each occurrence of R¹ and R² is independently selected from hydrogen and C₁-C₁ hydrocarbyl. (As used herein, the term “hydrocarbyl”, whether used by itself, or as a prefix, suffix, or fragment of another term, refers to a residue that contains only carbon and hydrogen. The residue may be aliphatic or aromatic, straight-chain, cyclic, bicyclic, branched, saturated, or unsaturated. It may also contain combinations of aliphatic, aromatic, straight chain, cyclic, bicyclic, branched, saturated, and unsaturated hydrocarbon moieties.) Methods for producing these poly(arylene ether) resins, sometimes called “dihydroxy” or “difunctional” or “bifunctional” poly(arylene ether) resins are described, for example, in U.S. Pat. No. 3,496,236 to Cooper et al., U.S. Pat. Nos. 4,140,675 and 4,165,422 and 4,234,706 to White, U.S. Pat. Nos. 4,521,584 and 4,677,185 to Heitz et al., U.S. Pat. Nos. 4,562,243 and 4,663,402 and 4,665,137 to Percec, U.S. Pat. No. 5,021,543 to Mayska et al., U.S. Pat. No. 5,880,221 to Liska et al., U.S. Pat. No. 5,965,663 to Hayase, U.S. Pat. No. 6,307,010 B1 to Braat et al., U.S. Pat. No. 6,569,982 to Hwang et al., and U.S. Pat. No. 6,794,481 to Amagai et al.

In one embodiment, the poly(arylene ether) resin comprises at least one terminal functional group selected from carboxylic acid, glycidyl ether, vinyl ether, and anhydride. A method for preparing a poly(arylene ether) resin substituted with terminal carboxylic acid groups is provided in the working examples, below. Other suitable methods include those described in, for example, European Patent No. 261,574 B1 to Peters et al. Glycidyl ether-functionalized poly(arylene ether) resins and methods for their preparation are described, for example, in U.S. Pat. No. 6,794,481 to Amagai et al. and U.S. Pat. No. 6,835,785 to Ishii et al., and U.S. Patent Application Publication No. 2004/0265595 A1 to Tokiwa. Vinyl ether-functionalized poly(arylene ether) resins and methods for there preparation are described, for example, in U.S. Statutory Invention Registration No. H521 to Fan. Anhydride-functionalized poly(arylene ether) resins and methods for their preparation are described, for example, in European Patent No. 261,574 B1 to Peters et al., and U.S. Patent Application Publication No. 2004/0258852 A1 to Ohno et al.

In one embodiment, the poly(arylene ether) resin is substantially free of particles having an equivalent spherical diameter greater than 100 micrometers. The poly(arylene ether) resin may also be free of particles having an equivalent spherical diameter greater than 80 micrometers, or greater than 60 micrometers. Methods of preparing such a poly(arylene ether) are known in the art and include, for example, sieving.

The curable composition may comprise about 2 to about 30 parts by weight of the poly(arylene ether) resin per 100 parts by weight total of the epoxy resin and the poly(arylene ether) resin. Within this range, the poly(arylene ether) amount may be at least about 5 parts by weight, or at least about 10 parts by weight. Also within this range, the poly(arylene ether) may be up to about 20 parts by weight, or up to about 15 parts by weight.

The curable composition comprises an amount of a latent cationic cure catalyst effective to cure the epoxy resin. A latent cationic cure catalyst is a compound capable of thermally generating a cationic cure catalyst, which in turn is capable of catalyzing epoxy homopolymerization. Suitable latent cationic cure catalysts include, for example, diaryliodonium salts, phosphonic acid esters, sulfonic acid esters, certain carboxylic acid esters, phosphonic ylides, benzylsulfonium salts, benzylpyridinium salts, benzylammonium slats, isoxazolium salts such as Woodward's reagent and Woodward's reagent K, and combinations thereof.

In one embodiment, the latent cationic cure catalyst comprises a diaryliodonium salt having the structure
[(R³)(R⁴)I]⁺X⁻
wherein R³ and R⁴ are each independently a C₆-C₁₄ monovalent aromatic hydrocarbon radical, optionally substituted with from 1 to 4 monovalent radicals selected from C₁-C₂₀ alkyl, C₁-C₂₀ alkoxy, nitro, chloro, and like radicals which are substantially inert under encapsulation conditions; and wherein X⁻ is an anion, preferably a weakly basic anion. Suitable diaryliodonium salts are described, for example, in U.S. Pat. No. 4,623,558 to Lin, U.S. Pat. No. 4,882,201 to Crivello et al., and U.S. Pat. No. 5,064,882 to Walles et al. In one embodiment, the anion X⁻ is an MQ_{d}⁻ anion, wherein M is a metal or metalloid, each occurrence of Q is independently halogen or perhalogenated phenyl, and d is an integer of 4 to 6. Suitable metals or metalloids, M, include metals such as Fe, Sn, Bi, Al, Ga, In, Ti, Zr, Sc, V, Cr, Mn, Cs; rare earth elements such as the lanthanides, for example, Cd, Pr, Nd, and the like, actinides, such as Th, Pa, U, Np, and the like; and metalloids such as B, P, As, Sb, and the like. In one embodiment, M is B, P, As, Sb or Ga. Representative MQ_{d}⁻ anions include, for example, BF₄⁻, B(C₆Cl₅)₄⁻, PF₆⁻, AsF₆⁻, SbF₆⁻, FeCl₄⁻, SnCl₆⁻, SbCl₆⁻, BiCl₅⁻, and the like.

In another embodiment, the latent cationic cure catalyst comprises a diaryliodonium salt having the structure
[(R³)(R⁴)I]⁺SbF₆⁻
wherein R³ and R⁴ are each independently a C₆-C₁₄ monovalent aromatic hydrocarbon radical, optionally substituted with from 1 to 4 monovalent radicals selected from C₁-C₂₀ alkyl, C₁-C₂₀ alkoxy, nitro, and chloro, and like radicals which are substantially inert under encapsulation conditions. An exemplary latent cationic cure catalyst is 4-octyloxyphenyl phenyl iodonium hexafluoroantimonate.

The curable composition comprises the latent cationic cure catalyst in an amount effective to cure the epoxy resin. The precise amount will depend on the type and amount of epoxy resin, the type of latent cationic cure catalyst, and the presence of other composition components that may accelerate or inhibit curing. Generally, the latent cationic cure catalyst will be present in an amount of about 0.1 to about 10 parts by weight per 100 parts by weight of the epoxy resin. Within this range, the amount may be at least about 0.2 parts by weight, or at least about 0.5 parts by weight. Also within this range, the amount may be up to about 5 parts by weight, or up to about 2 parts by weight.

The curable composition comprises about 70 to about 95 weight percent of an inorganic filler, based on the total weight of the curable composition. In one embodiment, the inorganic filler is selected from metal oxides, metal nitrides, metal carbonates, metal hydroxides, and combinations thereof. In one embodiment, the inorganic filler may be alumina, silica (including fused silica and crystalline silica), boron nitride (including spherical boron nitride), aluminum nitride, silicon nitride, magnesia, magnesium silicate, and the like, and combinations thereof. In one embodiment, the inorganic filler comprises a fused silica. In one embodiment, the inorganic filler comprises, based on the total weight of inorganic filler, about 75 to about 98 weight percent of a first fused silica having an average particle size of 1 micrometer to about 30 micrometers, and about 2 to about 25 weight percent of a second fused silica having an average particle size of about 0.03 micrometer to less than 1 micrometer. Within the above range, the amount of the first fused silica filler may be at least 80 weight percent, or at least 85 weight percent. Also within the above range, the amount of the first fused silica filler may be up to 95 weight percent, or up to 92 weight percent. Within the above range, the amount of the second fused silica filler may be at least about 5 weight percent, or at least about 8 weight percent. Also within the above range, the amount of the second fused silica filler may be up to about 20 weight percent, or up to about 15 weight percent.

The curable composition may, optionally, further comprise an effective amount of a curing co-catalyst. Suitable curing co-catalysts include, for example, free-radical generating aromatic compounds (e.g., benzopinacole), copper (II) salts of aliphatic carboxylic acids (e.g., copper (II) stearate), copper (II) salts of aromatic carboxylic acids (e.g., copper (II) benzoate, copper (II) naphthenate, and copper (II) salicylate), copper (II) acetylacetonate, peroxy compounds (e.g., t-butyl peroxybenzoate, 2,5-bis-t-butylperoxy-2,5-dimethyl-3-hexyne, and other peroxy compounds as described, for example, in U.S. Pat. No. 6,627,704 to Yeager et al.), and the like, and combinations thereof. In one embodiment, the curing co-catalyst comprises benzopinacole. In another embodiment, the curing co-catalyst comprises copper (II) acetylacetonate. A suitable amount of curing co-catalyst will depend on the type of co-catalyst, the type and amount of epoxy resin, and the type and amount of latent cationic cure catalyst, among other factors, but it is generally about 0.01 to about 20 parts by weight per 100 parts by weight of epoxy resin.

The curable composition may, optionally, further comprise a rubbery modifier selected from polybutadienes, hydrogenated polybutadienes, polyisoprenes, hydrogenated polyisoprenes, butadiene-styrene copolymers, hydrogenated butadiene-styrene copolymers, butadiene-acrylonitrile copolymers, hydrogenated butadiene-acrylonitrile copolymers, polydimethylsiloxanes, poly(dimethysiloxane-co-diphenylsiloxane)s, and combinations thereof; wherein the rubbery modifier comprises at least one functional group selected from hydroxy, hydrocarbyloxy, vinyl ether, carboxylic acid, anhydride, and glycidyl. Suitable rubbery modifiers include, for example, hydroxy-terminated polybutadienes, carboxy-terminated polybutadienes, maleic anhydride-functionalized (“maleinized”) polybutadienes, epoxy-terminated polybutadienes, hydroxy-terminated hydrogenated polybutadienes, carboxy-terminated hydrogenated polybutadienes, maleic anhydride-functionalized hydrogenated polybutadienes, epoxy-terminated hydrogenated polybutadienes, hydroxy-terminated styrene-butadiene copolymers (including, random, block, and graft copolymers), carboxy-terminated styrene-butadiene copolymers (including, random, block, and graft copolymers), maleic anhydride functionalized styrene-butadiene copolymers (including, random, block, and graft copolymers), epoxy-terminated styrene-butadiene copolymers (including, random, block, and graft copolymers), butadiene-acrylonitrile copolymers, hydrogenated butadiene-acrylonitrile copolymers, hydroxy-terminated (i.e., silanol-terminated) polydimethylsiloxanes, hydrocarbyloxy-terminated (i.e., carbinol-terminated) polydimethylsiloxanes, carboxy-terminated polydimethylsiloxanes, anhydride-terminated polydimethylsiloxanes, epoxy-terminated polydimethylsiloxanes, hydroxy-terminated poly(dimethysiloxane-co-diphenylsiloxane)s, carboxy-terminated poly(dimethysiloxane-co-diphenylsiloxane)s, anhydride-terminated poly(dimethysiloxane-co-diphenylsiloxane)s, epoxy-terminated poly(dimethysiloxane-co-diphenylsiloxane)s, the like, and combinations thereof. These rubbery modifiers and methods for their preparation are known in the art, and most are commercially available. A suitable amount of rubbery modifier will depend on the type of flame retardant, the type and amount of epoxy resin, the type and amount of polyphenylene ether, and the filler loading, among other factors, but it is generally about 1 to about 30 parts by weight per 100 parts by weight of the epoxy resin. Rubbery modifiers may be in the form of finely dispersed particles or reactive liquids.

The curable composition may, optionally, further comprise one or more additives known in the art. Such additives include, for example, phenolic hardeners, anhydride hardeners, silane coupling agents, flame retardants, mold release agents, pigments, thermal stabilizers, adhesion promoters, and the like, and combinations thereof. Those skilled in the art can select suitable additives and amounts. When phenolic hardeners and/or anhydride hardeners are present, they are used in an amount such that the primary curing mechanism is epoxy homopolymerization induced by the cure catalyst.

In one embodiment, the composition is substantially free of polystyrene polymers, including high impact polystyrenes. Such polystyrene polymers may be defined, for example, by reference to U.S. Pat. No. 6,518,362 to Clough et al.

One embodiment is a curable composition, comprising: about 70 to about 98 parts by weight of an epoxy resin comprising a monomeric epoxy resin and an oligomeric epoxy resin; about 2 to about 30 parts by weight of a poly(2,6-dimethyl-1,4-phenylene ether) resin having an intrinsic viscosity of about 0.05 to about 0.10 deciliters per gram at 25° C. in chloroform; an amount of a diaryliodonium salt effective to cure the epoxy resin; wherein the diaryliodonium salt has the structure
[(R¹⁰)(R¹¹)I]⁺SbF₆⁻
wherein R¹⁰ and R¹¹ are each independently a C₆-C₁₄ monovalent aromatic hydrocarbon radical, optionally substituted with from 1 to 4 monovalent radicals selected from C₁-C₂₀ alkyl, C₁-C₂₀ alkoxy, nitro, and chloro; and about 70 to about 95 weight percent silica filler, wherein the silica filler comprises about 75 to about 98 weight percent of a first fused silica having an average particle size of 1 micrometer to about 30 micrometers, and about 2 to about 25 weight percent of a second fused silica having an average particle size of about 0.03 micrometer to less than 1 micrometer; wherein the parts by weight of the epoxy resin and the poly(arylene ether) are based on 100 parts by weight total of the epoxy resin and the poly(arylene ether); and wherein the weight percent of the silica filler is based on the total weight of the curable composition.

As the composition is defined as comprising multiple components, it will be understood that each component is chemically distinct, particularly in the instance that a single chemical compound may satisfy the definition of more than one component.

The invention includes methods of preparing the curable composition. One such embodiment is a method of preparing a curable composition, the method comprising blending an epoxy resin, a poly(arylene ether) resin, an amount of a latent cationic cure catalyst effective to cure the epoxy resin, and about 70 to about 95 weight percent of an inorganic filler, based on the total weight of the curable composition, to form an intimate blend. Another embodiment is a method of preparing a curable composition, comprising: dry blending an epoxy resin, a poly(arylene ether) resin, an amount of a latent cationic cure catalyst effective to cure the epoxy resin, and about 70 to about 95 weight percent of an inorganic filler, based on the total weight of the curable composition, to form a first blend; melt mixing the first intimate blend at a temperature of about 90 to about 115° C. to form a second blend; cooling the second blend; and grinding the cooled second blend to form the curable composition.

The invention includes methods of encapsulating a solid state device with the curable composition. Thus, one embodiment is a method of encapsulating a solid state device, comprising: encapsulating a solid state device with a curable composition comprising an epoxy resin, a poly(arylene ether) resin, an amount of a latent cationic cure catalyst effective to cure the epoxy resin, and about 70 to about 95 weight percent of an inorganic filler, based on the total weight of the curable composition; and curing the composition. Curing the composition may, optionally, include post-curing the encapsulated devices (e.g., at about 150 to about 190° C. for about 0.5 to about 8 hours in a convection oven). Suitable methods for encapsulating solid state devices are known in the art and described, for example, in U.S. Pat. No. 5,064,882 to Walles, U.S. Pat. No. 6,632,892 B2 to Rubinsztajn et al., U.S. Pat. No. 6,800,373 B2 to Gorczyca, U.S. Pat. No. 6,878,783 to Yeager et al.; U.S. Patent Application Publication No. 2004/0166241 A1 to Gallo et al.; and International Patent Application No. WO 03/072628 A1 to Ikezawa et al.

The invention includes encapsulated devices prepared from the curable composition. Thus, one embodiment is an encapsulated solid state device, comprising: a solid state device; and a curable composition encapsulating the solid state device, wherein the curable composition comprises an epoxy resin, a poly(arylene ether) resin, an amount of a latent cationic cure catalyst effective to cure the epoxy resin, and about 70 to about 95 weight percent of an inorganic filler, based on the total weight of the curable composition. Such encapsulated solid state devices include those in which the resin composition is uncured, partially cured, and fully cured.

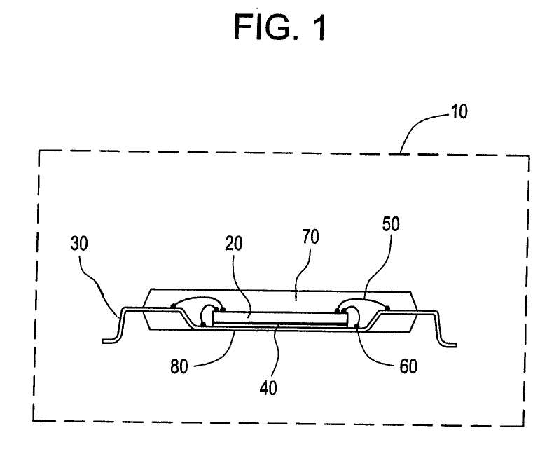

FIG. 1 is a side cross-sectional view of an encapsulated solid state device, 10. The solid state device 20 is attached to copper leadframe 30 via adhesive layer 40. The solid state device 10 is electrically connected to the copper leadframe 30 via gold wires 50 and ground bonds 60. Cured molding compound 70 encapsulates the solid state device 20, any exposed edges of the adhesive layer 40, gold wires 50, ground bonds 60, and a portion of the copper lead frame 30, leaving exposed the pad 80, corresponding to a surface of the copper leadframe 30 beneath the solid state device 20.

The invention is further illustrated by the following non-limiting examples.

### EXAMPLES 1-5

Table 1 presents the amounts of materials, expressed in parts by weight, combined to make Example Formulations 1-5. Example 1 had no polyphenylene ether. The other examples had poly(2,6-dimethyl-1,4-phenylene ether)s of different molecular weight (as measured by intrinsic viscosity (IV)). Examples 2-5 contained poly(2,6-dimethyl-1,4-phenylene ether)s of intrinsic viscosities 0.12, 0.20, 0.25, and 0.30, respectively. The polyphenylene ethers were passed through a 400 mesh sieve (opening size 37 micrometers) before formulation. “Denka FB570 silica” is a fused silica obtained from Denka having a median particle size of 17.7 micrometers and a surface area of 3.1 meter²/gram. “Denka SFP silica” is a fused silica obtained from Denka having a median particle size of 0.7 micrometers and a surface area of 6.2 meter²/gram. “Epoxy Silane”, obtained from GE Advanced Materials, is 2-(3,4-epoxycyclohexyl)-ethyl-trimethoxysilane. “Yuka RSS1407LC epoxy”, obtained from Yuka Shell, is 3,3′,5,5′-tetramethyl-4,4′-diglycidyloxybiphenyl. OPPI is 4-octyloxyphenyl phenyl iodonium hexafluoroantimonate available from GE Advanced Materials-Silicones as UV9392c.

Curable compositions were prepared by mixing the ingredients first in a Henschel mixer, and then passing them through a twin-screw extruder set at 60° C. in the rear section and 90° C. in the front. After cooling and hardening, the materials were then ground to a powder using a Retch mill.

Spiral flow lengths, expressed in centimeters (cm), were determined according to ASTM standard D3123-98 (also SEMI G11-88), using the standard spiral flow mold specified therein. A 20-gram charge of the molding compound was transferred into the spiral cavity of the tool, and the length traveled by the compound before flow stopped due to cure/pressure drop, was measured. The injection speed and injection pressure were kept constant across all formulations at 5.84 centimeters/second and 6.9 megapascals (MPa), respectively. Mold temperature was maintained at 175° C.

Specimens for flexural strength, thermomechanical analysis (TMA), and moisture absorption measurements were prepared by transfer molding as follows. A 15-ton resin transfer press (Fujiwa) was used. A four-cavity “Izod” specimen mold was used to transfer-mold a 35-gram charge of curable composition under an injection pressure of 6.9 MPa, at a ram speed of 2.54 millimeters/sec. The mold was maintained at 175° C., and a two-minute cure cycle was used. Specimens were post-cured in a forced-air convection oven for six hours at 175° C.

Thermomechanical analysis was used to determine the coefficient of thermal expansion (CTE) and the glass transition (T_{g}) of the molded EMC. Thermomechanical analysis was performed on a Perkin Elmer TMA 7 Instrument. Transfer-molded specimens measuring at least 3 millimeters (mm) in each dimension were used. The sample temperature was first ramped at 5° C./min from 25° C. to 250° C. then cooled at 5° C./min to 0° C. The second heat, used for analysis, ramped from 0° C. at 5° C./min to 250° C. An initial vertical probe force of 0.05 Newton was used. Glass transition temperature, T_{g}, was taken as the point of intersection of two tangents drawn to the dimension-temperature curve, at 50° C. and 190° C. The measurements are made under a Nitrogen atmosphere at 100 milliliters/minute. CTE values are expressed in units of parts per million per degree centigrade (ppm/° C.); CTE1 is the CTE value below T_{g}, and CTE2 is the CTE value above T_{g}.

Moisture absorption was measured according to SEMI G66-96 standard test method (saturated area), with the exception of the sample dimensions and drying schedule. Four transfer-molded specimens (6.35×1.25×0.3 cm in size, standard “Izod” dimensions) were used. The dry weight of each specimen was noted after oven drying for 1 hour at 110° C. The samples were then conditioned in a humidity controlled chamber at 85° C. and 85% RH for 168 hours. Moist weights were measured within about 10 minutes of removing the samples from the conditioning chamber, holding the specimens in a closed, humid container in the interim.

Adhesion to copper substrate was measured according to SEMI G69-0996, “Test Method for measurement of adhesive strength between leadframes and molding compounds”. The “pull” method was used, with a 5-mil thick copper substrate transfer-molded into a block of molding compound, 2.8 mm thick. (The leadframe and tool recommended by the SEMI standard were not used—however, the test specimen geometry is similar to the recommended standard.) The copper substrate used was EFTEC 64T ½ H grade from Furukawa Metals. The adhesive area (the triangular portion of the copper that was molded into the molding compound) was about 15.2 mm², including both sides. The adhesion of the mold compound to copper was tested by pulling the copper “tab” out of the mold compound using an Instron tensile tester, at the rate of 2 mm/min. The peak load was recorded and reported as the adhesive strength. The peak load was measured in pounds and converted to Newtons (N) for reporting.

To determine flexural strength, the samples (6.35 cm×1.27 cm×0.3175 cm) were tested at room temperature according to ASTM D790 for three-point bend flexural test.

TABLE 1

| Ingredient | Example 1 | Examples 2-5 |
|---|---|---|
| Denka FB570 Silica | 760.32 | 756.54 |
| Denka SFP Silica | 84.48 | 84.08 |
| Epoxy Silane | 4.97 | 4.97 |
| Yuka RSS1407LC Epoxy | 139.49 | 123.09 |
| OPPI | 2.98 | 5.58 |
| Benzopinacole | 1.79 | 3.35 |
| Polyphenylene ether | 0 | 16.40 |
| Carnauba Wax | 3.98 | 3.98 |
| Carbon Black | 1.99 | 2.00 |

Property results for Examples 1-5 are summarized in Table 2. The results show a reduction in moisture absorption for all poly(arylene ether)-containing samples (Exs. 2-5) and an increase in copper adhesion for two of four poly(arylene ether)-containing samples (Exs. 2 and 3), all relative to Ex. 1 without poly(arylene ether).

TABLE 2

| Test | Ex. 1 | Ex. 2 | Ex. 3 | Ex. 4 | Ex. 5 |
|---|---|---|---|---|---|
| Spiral Flow (cm) | 89.9 | 73.2 | 73.4 | 61.7 | 73.2 |
| CTE1 (ppm/° C.) | 13 | 11 | 12 | 12 | 12 |
| CTE2 (ppm/° C.) | 43 | 38 | 36 | 36 | 35 |
| T_{g} (° C.) | 127 | 120 | 118 | 126 | 119 |
| Moisture Abs. (%) | 0.285 | 0.264 | 0.268 | 0.266 | 0.267 |
| Adhesion (N) | 110 | 113 | 130 | 110 | 102 |
| Flex. Strength (MPa) | 118 | 100 | 99 | 107 | 95 |

### EXAMPLES 6-8

The formulations in Table 3 were mixed, molded, and tested as described for Examples 1-5. “Sumitomo ECN-195XL-25”, obtained from Sumitomo Chemical, is an epoxidized ortho-cresol novolac resin. Example 6 did not contain polyphenylene ether. Examples 7 and 8 contained poly(2,6-dimethyl-1,4-phenylene ether) resins with intrinsic viscosities of 0.12 and 0.30, respectively.

TABLE 3

| Ingredient | Example 6 | Examples 7 & 8 |
|---|---|---|
| Denka FB570 Silica | 1494.00 | 1494.00 |
| Denka SFP Silica | 166.00 | 166.00 |
| Epoxy Silane | 9.74 | 9.74 |
| Yuka RSS1407LC Epoxy | 214.82 | 182.59 |
| Sumitomo ECN-195XL-25 | 92.06 | 78.25 |
| OPPI | 7.67 | 7.67 |
| Benzopinacole | 4.60 | 4.60 |
| Polyphenylene ether | 0 | 46.03 |
| Carnauba Wax | 8.00 | 8.00 |
| Carbon Black | 4.00 | 4.00 |

Table 4 shows the results obtained for Examples 6-8. The results show that the poly(arylene ether)-containing Examples 7 and 8 exhibit reduced moisture absorption and increased copper adhesion relative to Example 6 without poly(arylene ether).

TABLE 4

| Test | Ex. 6 | Ex. 7 | Ex. 8 |
|---|---|---|---|
| Spiral Flow (cm) | 105.4 | 93.5 | 63 |
| CTE1 (ppm/° C.) | 14 | 13 | 13 |
| CTE2 (ppm/° C.) | 42 | 34 | 36 |
| T_{g} (° C.) | 137 | 132 | 136 |
| Moisture Abs. (%) | 0.332 | 0.296 | 0.306 |
| Adhesion (N) | 69 | 111 | 92 |
| Flex. Strength (MPa) | 123.5 | 101.5 | 117.1 |

### EXAMPLES 9 AND 10

The formulations in Table 5 were prepared and tested as described for Examples 1-5. Both Examples 9 and 10 included a poly(2,6-dimethyl-1,4-phenylene ether) having an intrinsic viscosity of 0.12 deciliters/gram at 25° C.

TABLE 5

| Ingredient | Ex. 9 | Ex. 10 |
|---|---|---|
| Denka FB570 Silica | 1521.00 | 1521.00 |
| Denka SFP Silica | 169.00 | 169.00 |
| Epoxy Silane | 10.00 | 10.00 |
| RSS1407LC Epoxy Resin | 55.38 | 47.08 |
| (Yuka Shell) | | |
| ECN-195XL-25 | 221.54 | 188.31 |
| (Sumitomo) | | |
| OPPI | 3.32 | 3.32 |
| Benzopinacole | 1.66 | 1.66 |
| Polyphenylene ether | 0 | 41.54 |
| Carnauba Wax | 8.00 | 8.00 |
| Carbon Black | 4.00 | 4.00 |

Property results for Examples 9 and 10 are presented in Table 6. The results show that Example 10, containing poly(arylene ether), exhibited reduced moisture absorption and increased copper adhesion relative to Example 9 without poly(arylene ether).

TABLE 6

| Test | Ex. 9 | Ex. 10 |
|---|---|---|
| Spiral Flow (cm) at 175° C. | 72.9 | 69.6 |
| Spiral Flow (cm) at 165° C. | 94.7 | 85.3 |
| CTE1 (ppm/° C.) | 11 | 13 |
| CTE2 (ppm/° C.) | 41 | 35 |
| T_{g} (° C.) | 142 | 141 |
| Moisture Abs. (%) | 0.323 | 0.298 |
| Adhesion (N) | 56 | 76 |
| Flex. Strength (MPa) | 137.7 | 114.7 |

### EXAMPLES 11-14

Four compositions varying in the type and amount of added poly(arylene ether) were prepared. Example 11 contained no poly(arylene ether), Example 12 contained “bifunctional” poly(2,6-dimethyl-1,4-phenylene ether) having an intrinsic viscosity of 0.12 deciliters per gram, Example 13 contained poly(2,6-dimethyl-1,4-phenylene ether) having an intrinsic viscosity of 0.086 deciliters per gram, and Example 14 contained poly(2,6-dimethyl-1,4-phenylene ether) having an intrinsic viscosity of 0.064 deciliters per gram. The formulations were initially prepared in two parts. The first part contained the following components: 229.50 grams FB570 spherical fused silica from Denka, 25.50 grams of SFP30 spherical fused silica from Denka, 0.90 grams of MICHEM® Wax 411 from Michelman, and 0.60 grams of Cabot BLACK PEARLS® 120. The poly(arylene ether)-containing compositions further contained 6.44 grams of the specified poly(arylene ether) in micronized form (i.e., passed through a 400 mesh sieve).

In separate containers, the resin portions of the formulations were prepared by mixing and melt blending 12.00 grams of RSS1407 LC Epoxy Resin (Yuka Shell), 48.00 grams of CNE195XL4 Epoxidized Cresol Novolac (Chang Chung), 0.60 grams of UV9392c Diaryliodonium Salt (GE Silicones), and 0.30 grams of copper acetylacetonate (Cu(acac)₂; Aldrich). This was done by combining the epoxy resins in a beaker, heating them with stirring in a 150° C. oil bath until they melted, then after cooling to about 100° C., adding the OPPI (UV9392c) and copper acetylacetonate. Once homogeneous, the molten resin blend was poured into the silica resin solid mix described above. These mixtures were then processed 6 times through a 2-roll mill with one roll set at 60° C. and the other at 90° C. The complete formulations are given in Table 7.

TABLE 7

| Component | Example 11 | Examples 12-14 |
|---|---|---|
| FB570 spherical fused silica | 229.50 | 229.50 |
| from Denka | | |
| SFP30 spherical fused silica | 25.50 | 25.50 |
| from Denka | | |
| MICHEM ® Wax 411 | 0.90 | 0.90 |
| from Michelman | | |
| Cabot BLACK PEARLS ® 120 | 0.60 | 0.60 |
| Poly (arylene ether) | 0 | 6.44 |
| RSS1407 LC Epoxy Resin (Yuka Shell) | 12.00 | 10.22 |
| CNE195XL4 Epoxidized Cresol | 48.00 | 40.89 |
| Novolac (Chang Chung) | | |
| OPPI | 0.60 | 0.51 |
| Copper Acetylacetonate (Aldrich) | 0.30 | 0.26 |

The compounds were molded on a transfer press at 165° C. After demolding the samples were then post-baked for two hours at 175° C. before testing. Gel time, which is a commonly used measure of cure speed, was measured as follows: a small portion of curable composition was placed on a metal plate which had been heated to 165° C.; the time at which the composition gels was determined by probing with a spatula or wooden tongue depressor. Other properties were measured as described above. Property results are summarized in Table 8. The results show that Examples 12-14, containing poly(arylene ether), exhibit substantially improved copper adhesion strength compared to Example 11 with no poly(arylene ether). Adhesion strengths were particularly and surprisingly improved for the Example 13 and 14 compositions containing poly(arylene ether) having intrinsic viscosities in the range 0.05-0.10 deciliters/gram. The results also show that the poly(arylene ether)-containing samples do not significantly inhibit curing in these compositions, where curing is catalyzed by a combination of an iodonium salt and copper acetylacetonate. In contrast, samples using a curing catalyst of iodonium salt plus benzopinacole showed substantial inhibition of curing when poly(arylene ether) was added.

TABLE 8

| Property | Ex. 11 | Ex. 12 | Ex. 13 | Ex. 14 |
|---|---|---|---|---|
| Gel Time at 165° C. (sec) | 11 | 12 | 10 | 9 |
| Spiral Flow at 165° C. (cm) | 90.2 | 50.8 | 47.8 | 45.7 |
| Cu Pull Tab Adhesion (N) | 35 | 69 | 197 | 170 |
| Flexural Strength (MPa) | 142 | 116 | 133 | 134 |
| Moisture Absorbance (%) | 0.214 | 0.222 | 0.247 | 0.226 |

### EXAMPLES 15-21

Seven conventionally cured compositions (i.e., without latent cationic cure catalyst) varying in type and amount of poly(arylene ether) were prepared and tested. The poly(2,6-dimethyl-1,4-phenylene ether) resins having intrinsic viscosities of 0.12 and 0.30 deciliters/gram used in Examples 16 and 17 were obtained from GE Advanced Materials. The poly(2,6-dimethyl-1,4-phenylene ether) resins having intrinsic viscosities of 0.058, 0.078, and 0.092 deciliters/gram used in Examples 19-21 were prepared by oxidative copolymerization of 2,6-xylenol and tetramethylbisphenol A and as described, for example, in U.S. Pat. No. 4,521,584 to Heitz et al. The epoxy resin gamma-glycidoxypropyltrimethoxysilane was obtained as Z6040 from Dow. The compositions were prepared by mixing the ingredients first in a Henschel mixer, and then passing them through a twin-screw extruder set at 60° C. in the rear section and 90° C. in the front section. After cooling and hardening, the materials were then ground to a powder using a Retch mill. Sample compositions are detailed in Table 9, with component amounts given in parts by weight.

TABLE 9

| Component | Ex. 15 | Ex. 16 | Ex. 17 |
|---|---|---|---|
| FB570 Silica (Denka) | 1476.0 | 1476.0 | 1476.0 |
| SFP30 Silica (Denka) | 164.00 | 164.00 | 164.00 |
| Z6040 Silane (Dow Corning) | 10.93 | 10.93 | 10.93 |
| RSS1407LC Epoxy Resin | 63.04 | 53.58 | 53.58 |
| (Yuka Shell) | | | |
| CNE 195XL-4 ECN | 136.79 | 116.27 | 116.27 |
| (Chang Chung) | | | |
| Tamanol 758 Phenol Novolac | 97.45 | 82.83 | 82.83 |
| (Arakawa) | | | |
| Triphenyl Phosphine (Aldrich) | 4.77 | 4.06 | 4.06 |
| 0.12 IV PPE | 0 | 50.86 | 0 |
| (GE Advanced Materials) | | | |
| 0.30 IV PPE | 0 | 0 | 50.86 |
| (GE Advanced Materials) | | | |
| 0.058 IV PPE | 0 | 0 | 0 |
| 0.078 IV PPE | 0 | 0 | 0 |
| 0.092 IV PPE | 0 | 0 | 0 |
| Carnauba Wax (Michelman) | 6.00 | 6.00 | 6.00 |
| Black Pearls 120 (Cabot) | 4.00 | 4.00 | 4.00 |
| Antimony Oxide | 16.04 | 16.04 | 16.04 |
| Tetrabromo Bisphenol A | 20.97 | 20.97 | 20.97 |
| (Great Lakes) | | | |

| Component | Ex. 18 | Ex. 19 | Ex. 20 | Ex. 21 |
|---|---|---|---|---|
| FBS70 Silica (Denka) | 1107.0 | 1107.0 | 1107.0 | 1107.0 |
| SFP30 Silica (Denka) | 123.0 | 123.0 | 123.0 | 123.0 |
| Z6040 Silane (Dow Corning) | 8.20 | 8.20 | 8.20 | 8.20 |
| RSS1407LC Epoxy Resin | 47.28 | 40.19 | 40.19 | 40.19 |
| (Yuka Shell) | | | | |
| CNE 195XL-4 ECN | 102.6 | 87.21 | 87.21 | 87.21 |
| (Chang Chung) | | | | |
| Tamanol 758 Phenol Novolac | 73.09 | 62.12 | 62.12 | 62.12 |
| (Arakawa) | | | | |
| Triphenyl Phosphine (Aldrich) | 3.58 | 3.04 | 3.04 | 3.04 |
| 0.12 IV PPE | 0 | 0 | 0 | 0 |
| (GE Advanced Materials) | | | | |
| 0.30 IV PPE | 0 | 0 | 0 | 0 |
| (GE Advanced Materials) | | | | |
| 0.058 IV PPE | 0 | 38.14 | 0 | 0 |
| 0.078 IV PPE | 0 | 0 | 38.14 | 0 |
| 0.092 IV PPE | 0 | 0 | 0 | 38.14 |
| Carnauba Wax (Michelman) | 4.50 | 4.50 | 4.50 | 4.50 |
| Black Pearls 120 (Cabot) | 3.00 | 3.00 | 3.00 | 3.00 |
| Antimony Oxide | 12.03 | 10.22 | 10.22 | 10.22 |
| Tetrabromo Bisphenol A | 15.73 | 13.37 | 13.37 | 13.37 |
| (Great Lakes) | | | | |

The formulations were molded on a transfer press at 175° C. After demolding, the parts were then post-baked at 175° C. for 6 hours before testing. Property values, measured as described above, are given in Table 10. The results show that in the conventionally cured epoxy compositions, copper adhesion is nearly independent of the type or amount of poly(arylene ether) present. This further illustrates that the high adhesion strengths observed for cationically cured compositions 13 and 14 with low intrinsic viscosity poly(arylene ether) resins are unexpected and surprising.

TABLE 10

| Property | Ex. 15 | Ex. 16 | Ex. 17 | Ex. 18 | Ex. 19 | Ex. 20 | Ex. 21 |
|---|---|---|---|---|---|---|---|
| Gel Time at 175° C. | 25 | 26 | 24 | 23 | 24 | 22 | 26 |
| (sec) | | | | | | | |
| Spiral Flow at 175° C. | 129.5 | 68.6 | 71.1 | 129.5 | 114.3 | 99.1 | 99.1 |
| (cm) | | | | | | | |
| CTE1 (ppm/° C.) | 12 | 11 | 12 | — | — | — | — |
| CTE2 (ppm/° C.) | 44 | 39 | 44 | — | — | — | — |
| Tg (° C.) | 139 | 146 | 144 | — | — | — | — |
| Cu Pull Tab Adhesion | 85 | 96 | 88 | 76 | 84 | 88 | 92 |
| (N) | | | | | | | |
| Flex. Strength (MPa) | 126 | 115 | 120 | 132 | 118 | 126 | 136 |
| Moisture Absorbance | 0.245 | 0.239 | 0.260 | 0.230 | 0.211 | 0.201 | 0.199 |
| (%) | | | | | | | |

### EXAMPLE 22

The example describes the preparation of an acid-difunctionalized poly(arylene ether). A bifunctional poly(arylene ether) having an intrinsic viscosity of 0.12 deciliters/gram at 25° C. in chloroform was synthesized by the oxidative copolymerization of 2,6-xylenol and 2,2-bis(4-hydroxy-2,6-dimethylphenyl)propane (“tetramethyl bisphenol A” or “TMBPA”) using a procedure similar to those described in U.S. Pat. No. 4,665,137 to Percec (at columm 5, lines 39-43) and U.S. Pat. No. 4,677,185 to Heitz et al. The bifunctional poly(arylene ether) (50 grams) was dissolved in toluene (150 milliliters) and reacted with succinic anhydride (6.4 grams) in the presence of 4-dimethylaminopyridine (“DMAP”; 0.4 grams) for four hours at 95-100° C. to yield an acid-difunctionalized poly(arylene ether), as showing in Scheme 1, below. In Scheme 1, a and b have values such that the sum of a and b is sufficient to give the bifunctional poly(arylene ether) an intrinsic viscosity of 0.12 deciliters per gram. The solvent was then removed on a rotary evaporator and then excess succinic anhydride and most of the DMAP were removed by washing with methanol. After drying, about 45.1 g of product was obtained. As a final purification (to make sure all the DMAP was gone) the product was dissolved in 150 milliliters of toluene and then precipitated into 1000 milliliters methanol containing 0.3 gram of toluene sulfonic acid. After collection by suction filtration the product was washed two times with methanol and then dried again in a vacuum oven. The final yield was 41.4 g.

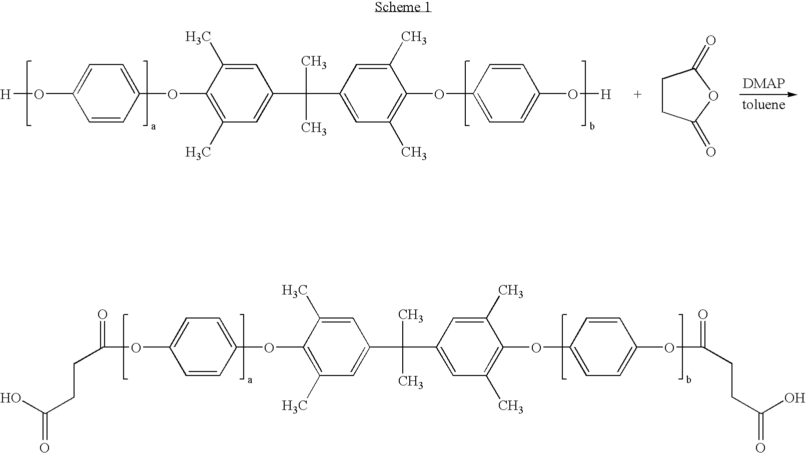

### EXAMPLE 23

The example describes the preparation and testing of a curable composition containing the acid-difunctionalized poly(arylene ether) prepared in Example 22. The formulation was initially prepared in two parts. The first part contained the following components: 229.50 grams FB570 spherical fused silica from Denka, 25.50 grams of SFP30 spherical fused silica from Denka, 0.90 grams of MICHEM® Wax 411 from Michelman, 0.60 gram of carbon black obtained as Cabot BLACK PEARLS® 120s, and 6.42 grams of micronized (passed through a 325 mesh sieve) acid-difunctionalized poly(arylene ether) as prepared above.

In separate containers, the resin portions of the formulations were prepared by mixing and melt blending 10.18 grams of RSS1407 LC Epoxy Resin (Yuka Shell), 40.72 grams of CNE195XL4 Epoxidized Cresol Novolac (Chang Chung), 0.51 gram of OPPI (UV9392c Diaryliodonium Salt, GE Silicones), and 0.51 gram benzopinacole (Aldrich). This was done by combining the epoxy resins in a beaker, heating them with stirring in a 150° C. oil bath until they melted, then after cooling to about 100° C., and adding the UV9392c and benzopinacole. Once homogeneous, the molten resin blend was poured into the silica resin solid mix described above. The resulting mixture was then processed 6 times through a 2-roll mill with one roll set at 60° C. and the other at 90° C. The complete composition is provided in Table 11.

TABLE 11

| Component | Example 23 |
|---|---|
| FB570 spherical fused silica from Denka | 229.50 |
| SFP30 spherical fused silica from Denka | 25.50 |
| MICHEM ® Wax 411 from Michelman | 0.90 |
| Cabot BLACK PEARLS ® 120s | 0.60 |
| acid-difunctionalized poly(arylene ether) | 6.42 |
| RSS1407 LC Epoxy Resin (Yuka Shell) | 10.18 |
| CNE195XL4 Epoxidized Cresol Novolac (Chang Chung) | 40.72 |
| OPPI | 0.51 |
| Benzopincole (Aldrich) | 0.51 |

The compound was molded on a transfer press at 175° C. After demolding, the samples were then post-baked for two hours at 175° C. before testing. Property values are provided in Table 12.

TABLE 12

| Property | Example 23 |
|---|---|
| Gel Time at 175° C. (sec) | 12-13 |
| Spiral Flow at 175° C. (cm) | 68.1 |
| Cu Pull Tab Adhesion (N) | 52 |
| Flexural Strength (MPa) | 129 |
| Moisture Absorbance (%) | 0.255 |

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

All cited patents, patent applications, and other references are incorporated herein by reference in their entirety.

All ranges disclosed herein are inclusive of the endpoints, and the endpoints are combinable with each other.

The use of the terms “a” and “an” and “the” and similar referents in the context of describing the invention (especially in the context of the following claims) are to be construed to cover both the singular and the plural, unless otherwise indicated herein or clearly contradicted by context.

1. A curable composition, comprising:
an epoxy resin;
a poly(arylene ether) resin;
an amount of a latent cationic cure catalyst effective to cure the epoxy resin;
about 70 to about 95 weight percent of an inorganic filler, based on the total weight of the curable composition.

2. The curable composition of claim 1, wherein the epoxy resin comprises an epoxy resin having a softening point of about 25° C. to about 150° C.

3. The curable composition of claim 1, wherein the epoxy resin is selected from aliphatic epoxy resins, cycloaliphatic epoxy resins, bisphenol-A epoxy resins, bisphenol-F epoxy resins, phenol novolac epoxy resins, cresol-novolac epoxy resins, biphenyl epoxy resins, polyfunctional epoxy resins, naphthalene epoxy resins, divinylbenzene dioxide, 2-glycidylphenylglycidyl ether, dicyclopentadiene-type epoxy resins, multi aromatic resin type epoxy resins, and combinations thereof.

4. The curable composition of claim 1, wherein the epoxy resin comprises a monomeric epoxy resin and an oligomeric epoxy resin.

5. The curable composition of claim 1, comprising about 70 to about 98 parts by weight of the epoxy resin per 100 parts by weight total of the epoxy resin and the poly(arylene ether) resin.

6. The curable composition of claim 1, wherein the poly(arylene ether) resin comprises a plurality of repeating units having the structure 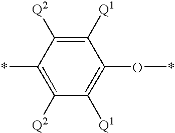
wherein each occurrence of Q² is independently selected from hydrogen, halogen, primary or secondary C₁-C₁₂ alkyl, C₂-C₁₂ alkenyl, C₃-C₁₂ alkenylalkyl, C₂-C₁₂ alkynyl, C₃-C₁₂ alkynylalkyl, C₁-C₁₂ hydroxyalkyl, phenyl, C₁-C₁₂ haloalkyl, C₁-C₁₂ hydrocarbyloxy, and C₂-C₁₂ halohydrocarbyloxy wherein at least two carbon atoms separate the halogen and oxygen atoms; and wherein each occurrence of Q¹ is independently selected from halogen, primary or secondary C₁-C₁₂ alkyl, C₂-C₁₂ alkenyl, C₃-C₁₂ alkenylalkyl, C₂-C₁₂ alkynyl, C₃-C₁₂ alkynylalkyl, C₁-C₁₂ hydroxyalkyl, phenyl, C₁-C₁₂ haloalkyl, C₁-C₁₂ hydrocarbyloxy, and C₂-C₁₂ halohydrocarbyloxy wherein at least two carbon atoms separate the halogen and oxygen atoms.

7. The curable composition of claim 1, wherein the poly(arylene ether) has an intrinsic viscosity of about 0.03 to about 1.0 deciliters per gram measured at 25° C. in chloroform.

8. The curable composition of claim 1, wherein the poly(arylene ether) resin has an intrinsic viscosity of about 0.03 to 0.15 deciliters per gram measured at 25° C. in chloroform.

9. The curable composition of claim 1, wherein the poly(arylene ether) resin has the structure 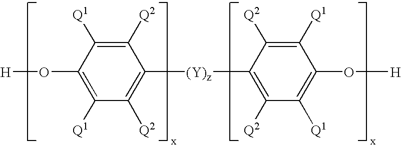
wherein each occurrence of Q² is independently selected from hydrogen, halogen, primary or secondary C₁-C₁₂ alkyl, C₂-C₁₂ alkenyl, C₃-C₁₂ alkenylalkyl, C₂-C₁₂ alkynyl, C₃-C₁₂ alkynylalkyl, C₁-C₁₂ hydroxyalkyl, phenyl, C₁-C₁₂ haloalkyl, C₁-C₁₂ hydrocarbyloxy, and C₂-C₁₂ halohydrocarbyloxy wherein at least two carbon atoms separate the halogen and oxygen atoms; and wherein each occurrence of Q¹ is independently selected from hydrogen, halogen, primary or secondary C₁-C₁₂ alkyl, C₂-C₁₂ alkenyl, C₃-C₁₂ alkenylalkyl, C₂-C₁₂ alkynyl, C₃-C₁₂ alkynylalkyl, C₁-C₁₂ hydroxyalkyl, phenyl, C₁-C₁₂ haloalkyl, C₁-C₁₂ hydrocarbyloxy, and C₂-C₁₂ halohydrocarbyloxy wherein at least two carbon atoms separate the halogen and oxygen atoms; each occurrence of x is independently 1 to about 100; z is 0 or 1; and Y has a structure selected from 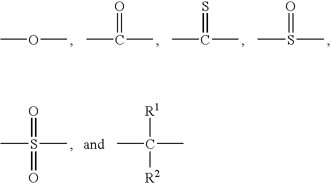
wherein each occurrence of R¹ and R² is independently selected from hydrogen and C₁-C₁₂ hydrocarbyl.

10. The curable composition of claim 1, wherein the poly(arylene ether) resin comprises at least one terminal functional group selected from carboxylic acid, glycidyl ether, vinyl ether, and anhydride.

11. The curable composition of claim 1, wherein the poly(arylene ether) resin is substantially free of particles having an equivalent spherical diameter greater than 100 micrometers.

12. The curable composition of claim 1, comprising about 2 to about 30 parts by weight of the poly(arylene ether) resin per 100 parts by weight total of the epoxy resin and the poly(arylene ether) resin.

13. The curable composition of claim 1, wherein the latent cationic cure catalyst is selected from diaryliodonium salts, phosphonic acid esters, sulfonic acid esters, carboxylic acid esters, phosphonic ylides, benzylsulfonium salts, benzylpyridinium salts, benzylammonium salts, isoxazolium salts, and combinations thereof.

14. The curable composition of claim 1, wherein the latent cationic cure catalyst comprises a diaryliodonium salt having the structure
[(R³)(R⁴)I]⁺X⁻
wherein R³ and R⁴ are each independently a C₆-C₁₄ monovalent aromatic hydrocarbon radical, optionally substituted with from 1 to 4 monovalent radicals selected from C₁-C₂₀ alkyl, C₁-C₂₀ alkoxy, nitro, and chloro; and wherein X⁻ is an anion.

15. The curable composition of claim 1, wherein the latent cationic cure catalyst comprises a diaryliodonium salt having the structure
[(R³)(R⁴)I]⁺SbF₆⁻
wherein R³ and R⁴ are each independently a C₆-C₁₄ monovalent aromatic hydrocarbon radical, optionally substituted with from 1 to 4 monovalent radicals selected from C₁-C₂₀ alkyl, C₁-C₂₀ alkoxy, nitro, and chloro.

16. The curable composition of claim 1, wherein the latent cationic cure catalyst comprises 4-octyloxyphenyl phenyl iodonium hexafluoroantimonate.

17. The curable composition of claim 1, comprising about 0.1 to about 10 parts by weight of the latent cationic cure catalyst per 100 parts by weight of the epoxy resin.

18. The curable composition of claim 1, wherein the inorganic filler is selected from metal oxides, metal nitrides, metal carbonates, metal hydroxides, and combinations thereof.

19. The curable composition of claim 1, wherein the inorganic filler is selected from alumina, silica, boron nitride, aluminum nitride, silicon nitride, magnesia, magnesium silicate, and combinations thereof.

20. The curable composition of claim 1, wherein the inorganic filler comprises a fused silica.

21. The curable composition of claim 1, wherein the inorganic filler comprises, based on the total weight of inorganic filler, about 75 to about 98 weight percent of a first fused silica having an average particle size of 1 micrometer to about 30 micrometers, and about 2 to about 25 weight percent of a second fused silica having an average particle size of about 0.03 micrometer to less than 1 micrometer.

22. The curable composition of claim 1, further comprising an effective amount of a curing co-catalyst selected from free-radical generating aromatic compounds, peroxy compounds, copper (II) salts of aliphatic carboxylic acids, copper (II) salts of aromatic carboxylic acids, copper (II) acetylacetonate, and combinations thereof.

23. The curable composition of claim 22, wherein the curing co-catalyst comprises benzopinacole.

24. The curable composition of claim 22, wherein the curing co-catalyst comprises copper (II) acetylacetonate.

25. The curable composition of claim 1, further comprising a rubbery modifier selected from polybutadienes, hydrogenated polybutadienes, polyisoprenes, hydrogenated polyisoprenes, butadiene-styrene copolymers, hydrogenated butadiene-styrene copolymers, butadiene-acrylonitrile copolymers, hydrogenated butadiene-acrylonitrile copolymers, polydimethylsiloxanes, poly(dimethysiloxane-co-diphenylsiloxane)s, and combinations thereof; wherein the rubbery modifier comprises at least one functional group selected from hydroxy, hydrocarbyloxy, vinyl ether, carboxylic acid, anhydride, and glycidyl.

26. The curable composition of claim 1, further comprising an additive selected from phenolic hardeners, anhydride hardeners, silane coupling agents, flame retardants, mold release agents, pigments, thermal stabilizers, adhesion promoters, and combinations thereof.

27. The curable composition of claim 1, wherein the composition is substantially free of polystyrene.

28. A curable composition, comprising:
about 70 to about 98 parts by weight of an epoxy resin comprising a monomeric epoxy resin and an oligomeric epoxy resin;
about 2 to about 30 parts by weight of a poly(2,6-dimethyl-1,4-phenylene ether) resin having an intrinsic viscosity of about 0.05 to about 0.10 deciliters per gram at 25° C. in chloroform;
an amount of a diaryliodonium salt effective to cure the epoxy resin; wherein the diaryliodonium salt has the structure
[(R¹⁰)(R¹¹)I]⁺SbF₆⁻
wherein R¹⁰ and R¹¹ are each independently a C₆-C₁₄ monovalent aromatic hydrocarbon radical, optionally substituted with from 1 to 4 monovalent radicals selected from C₁-C₂₀ alkyl, C₁-C₂₀ alkoxy, nitro, and chloro; and
about 70 to about 95 weight percent silica filler, wherein the silica filler comprises about 75 to about 98 weight percent of a first fused silica having an average particle size of 1 micrometer to about 30 micrometers, and about 2 to about 25 weight percent of a second fused silica having an average particle size of about 0.03 micrometer to less than 1 micrometer;
wherein the parts by weight of the epoxy resin and the poly(arylene ether) are based on 100 parts by weight total of the epoxy resin and the poly(arylene ether); and wherein the weight percent of the silica filler is based on the total weight of the curable composition.

29. A method of preparing a curable composition, comprising
blending
an epoxy resin,
a poly(arylene ether) resin,
an amount of a latent cationic cure catalyst effective to cure the epoxy resin, and
about 70 to about 95 weight percent of an inorganic filler, based on the total weight of the curable composition,
to form an intimate blend.

30. A method of preparing a curable composition, comprising:
dry blending an epoxy resin, a poly(arylene ether) resin, an amount of a latent cationic cure catalyst effective to cure the epoxy resin, and about 70 to about 95 weight percent of an inorganic filler, based on the total weight of the curable composition, to form a first blend;
melt mixing the first blend at a temperature of about 90 to about 115° C. to form a second blend;
cooling the second blend; and
grinding the cooled second blend to form the curable composition.

31. A method of encapsulating a solid state device, comprising:
encapsulating a solid state device with a curable composition comprising
an epoxy resin;
a poly(arylene ether) resin;
an amount of a latent cationic cure catalyst effective to cure the epoxy resin; and
about 70 to about 95 weight percent of an inorganic filler, based on the total weight of the curable composition; and
curing the curable composition.

32. An encapsulated solid state device, comprising:
a solid state device; and
a cured composition encapsulating the solid state device, wherein the cured composition comprises the products obtained on curing a curable composition comprising
an epoxy resin;
a poly(arylene ether) resin;
an amount of a latent cationic cure catalyst effective to cure the epoxy resin; and
about 70 to about 95 weight percent of an inorganic filler, based on the total weight of the curable composition.
